(19) United States
(12) Patent Application Publication
(10) Pub. No.: US 2026/0006443 A1
(43) Pub. Date: Jan. 1, 2026

(54) DOWNLINK CONTROL INFORMATION (DCI) PROTECTION

(71) Applicant: QUALCOMM Incorporated, San Diego, CA (US)

(72) Inventors: Soo Bum LEE, San Diego, CA (US); Sitaramanjaneyulu KANAMARLAPUDI, San Diego, CA (US); Gavin Bernard HORN, La Jolla, CA (US)

(21) Appl. No.: 18/761,053

(22) Filed: Jul. 1, 2024

(51) Int. Cl. H04W 12/08; H04L 1/00; H04W 12/041; H04W 12/106; H04W 72/231

(52) U.S. Cl. CPC H04W 12/08; H04L 1/0061; H04W 12/041; H04W 12/106; H04W 72/231

(57) ABSTRACT

Disclosed are systems and techniques for wireless communications. For instance, a process can include establishing, by a wireless device (e.g., a user equipment (UE)), access stratum (AS) security between the wireless device and a network node; generating a downlink control information (DCI) encryption key based on a physical layer encryption key generated from an AS key shared with the network node; receiving a DCI transmission from the network node; and decrypting the DCI transmission using the DCI encryption key to obtain scheduling information for the wireless device.

### FIELD

The present disclosure generally relates to wireless communications. For example, aspects of the present disclosure relate to systems and techniques for providing downlink control information (DCI) protection for wireless communications systems.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. The sixth-generation (6G) mobile standard is currently in development. 6G will build on 5G, using higher radio frequencies to provide more bandwidth, lower latency, and higher capacity.

Although wireless communications systems have made great technological advancements over many years, challenges still exist. For example, downlink control information (DCI) may be used to schedule when a wireless device, such as user equipment (UE), may transmit or receive information from a network node, such as a base station (BS). In some cases, the DCI information for a particular UE is not protected and an eavesdropper may potentially identify resources scheduled for the particular UE for targeted attacks. Techniques for protecting DCI information may be useful to avoid such attacks.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. In one illustrative example, an apparatus for wireless communications is provided. The apparatus includes at least one memory and at least one processor (e.g., implemented in circuitry) coupled to the at least one memory. The at least one processor is configured to: establish access stratum (AS) security between the apparatus and a network node; generate a downlink control information (DCI) encryption key based on a physical layer encryption key generated from an AS key shared with the network node; receive a DCI transmission from the network node; and decrypt the DCI transmission using the DCI encryption key to obtain scheduling information for the apparatus.

As another example, a method for wireless communications is provided. The method includes: establishing, by a wireless device, access stratum (AS) security between the wireless device and a network node; generating a downlink control information (DCI) encryption key based on a physical layer encryption key generated from an AS key shared with the network node; receiving a DCI transmission from the network node; and decrypting the DCI transmission using the DCI encryption key to obtain scheduling information for the wireless device.

In another example, a non-transitory computer-readable medium that has stored thereon instructions is provided. The instructions, when executed by at least one processor, cause the at least one processor to: establish access stratum (AS) security between the apparatus and a network node; generate a downlink control information (DCI) encryption key based on a physical layer encryption key generated from an AS key shared with the network node; receive a DCI transmission from the network node; and decrypt the DCI transmission using the DCI encryption key to obtain scheduling information for the apparatus.

As another example, an apparatus for wireless communications is provided. The apparatus includes: means for establishing, by a wireless device, access stratum (AS) security between the wireless device and a network node; means for generating a downlink control information (DCI) encryption key based on a physical layer encryption key generated from an AS key shared with the network node; means for receiving a DCI transmission from the network node; and means for decrypting the DCI transmission using the DCI encryption key to obtain scheduling information for the wireless device.

In another example, an apparatus for wireless communications is provided. The apparatus includes at least one memory and at least one processor (e.g., implemented in circuitry) coupled to the at least one memory. The at least one processor is configured to: establish access stratum (AS) security between the apparatus and a wireless device; generate a downlink control information (DCI) encryption key based on a physical layer encryption key generated from an AS key; generate a DCI message based on scheduling information for the wireless device; encode the DCI message based on the DCI encryption key; and transmit the DCI message in a DCI transmission to the wireless device.

As another example, a method for wireless communications is provided. The method includes: establishing access stratum (AS) security between the apparatus and a wireless device; generating a downlink control information (DCI) encryption key based on a physical layer encryption key generated from an AS key; generating a DCI message based on scheduling information for the wireless device; encoding the DCI message based on the DCI encryption key; and transmitting the DCI message in a DCI transmission to the wireless device.

In another example, a non-transitory computer-readable medium that has stored thereon instructions is provided. The instructions, when executed by at least one processor, cause the at least one processor to: establish access stratum (AS) security between the apparatus and a wireless device; generate a downlink control information (DCI) encryption key based on a physical layer encryption key generated from an AS key; generate a DCI message based on scheduling information for the wireless device; encode the DCI message based on the DCI encryption key; and transmit the DCI message in a DCI transmission to the wireless device.

As another example, an apparatus for wireless communications is provided. The apparatus includes: means for establishing access stratum (AS) security between the apparatus and a wireless device; means for generating a downlink control information (DCI) encryption key based on a physical layer encryption key generated from an AS key; means for generating a DCI message based on scheduling information for the wireless device; means for encoding the DCI message based on the DCI encryption key; and means for transmitting the DCI message in a DCI transmission to the wireless device.

In some aspects, one or more of the apparatuses described herein is, is a part of, or includes a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIGS. 5A-5D depict various example aspects of data structures for a wireless communication network, in accordance with some examples;

FIG. 6 illustrates an example connection procedure to establish a connection with a wireless network, in accordance with aspects of the present disclosure;

FIG. 7 illustrates a key hierarchy for AS security of a wireless system, in accordance with aspects of the present disclosure;

FIG. 8 is a flow diagram of a process for wireless communications, in accordance with aspects of the present disclosure;

FIG. 9 is a flow diagram of a process for wireless communications, in accordance with aspects of the present disclosure; and

FIG. 10 is a diagram illustrating an example of a computing system, according to aspects of the disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

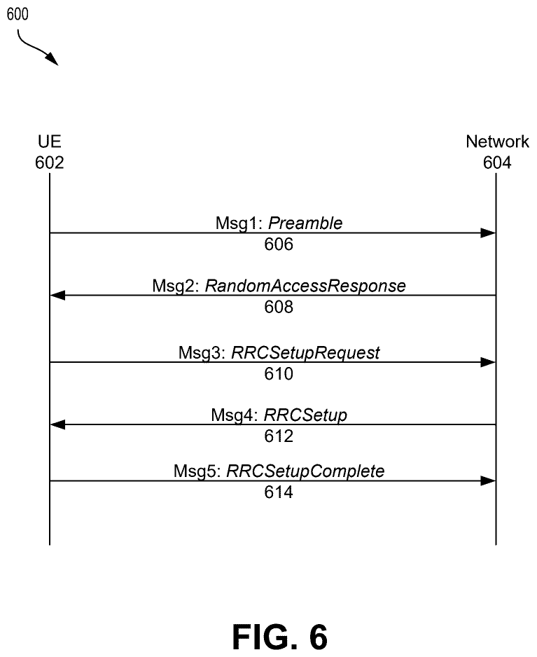

In some cases, user equipment (UE) may establish certain connections with a network node of a wireless network (e.g., a 5G wireless communication network, etc.) and listen for downlink control information (DCI) indicating when the UE may transmit or receive information (e.g., scheduling information). While the DCI for a UE may be scrambled by a cell radio network temporary identifier (C-RNTI) exchanged during an attachment (e.g., a random access (RA) procedure (e.g., when connecting with the network node, such as described with respect to FIG. 6), it may be possible for an attacker to unscramble the DCI and/or modify/spoof the DCI if the attacker obtains the C-RNTI (e.g., the C-RNTI may be transmitted in the clear during the attachment procedure, such as during a RA procedure). Thus, techniques to protect DCI may be useful.

Systems, apparatuses, electronic devices, methods (also referred to as processes), and computer-readable media (collectively referred to herein as “systems and techniques”) are described herein for providing techniques for protecting a DCI in a wireless communications system (e.g., a 4G, 5G, 6G, and/or other wireless communications system). For example, DCI protection may be provided using ciphering, integrity protection, or both to the DCI transmission. Ciphering the DCI information may help hide information about which UE is scheduled for a particular resource and integrity protection may provide information about whether the DCI was tampered with (e.g., spoofing the DCI, modifying information in the DCI, injecting false DCI information into the DCI, etc.). As used herein, the term security key, cryptographic key, encryption key, and key may be used interchangeably.

In an example of ciphering, as a part of establishing access stratum (AS) security, a physical layer (PHY) security key (e.g., cryptographic key) is derived (or agreed to) based parameter(s) exchanged between a UE and a network node. A DCI encryption key can be derived (e.g., by the network node) based on the PHY security key by the UE and the network node. The network node can encode a DCI transmission to the UE using its DCI encryption key. Encoding may include encryption. The UE can decode the DCI transmission using its DCI encryption key. Decoding may include decryption.

As an example of integrity protection, a DCI integrity protection key can be derived (e.g., by the network node) based on the PHY security key by the UE and the network node. A message authentication code (MAC) can be generated (e.g., by the network node) based on a DCI message using the DCI integrity protection key. The MAC can be attached to the DCI message and transmitted (e.g., by the network node) as the DCI transmission to the UE. The integrity of a DCI transmission can be verified by the UE by generating a version of the MAC using the DCI message in the DCI transmission and DCI integrity protection key derived based on the PHY security key (as is done by the network node), and comparing the version of the MAC to the MAC included in the DCI transmission. In some aspects, the DCI transmission may include a cyclic redundancy check (CRC) message. In some cases, the CRC message may be omitted from the DCI to reduce a size of the DCI transmission. In such cases, the DCI can include a MAC instead of the CRC message. In some aspects, the DCI message (and CRC message, if used) may be encrypted before the MAC is determined. In other aspects, the MAC may be determined based on the unencrypted DCI message (and CRC message, if used) and the DCI message and MAC may be encrypted together. In such aspects, the UE may decrypt the DCI transmission before verifying the MAC.

In some cases, an enhanced CRC (eCRC) message can be used for DCI protection. The eCRC can be based on using a C-RNTI of a UE in a CRC calculation. In some cases, the C-RNTI is sent to the UE by the network node using a secure RRC message to avoid an attacker/adversary from obtaining the C-RNTI. For example, a CRC (e.g., eCRC) may be determined (e.g., calculated) based on the DCI message and the C-RNTI of the UE. For example, content of the DCI message can be concatenated with the eCRC. The concatenated DCI message and eCRC can be encoded using the DCI encryption key for transmission. To verify the eCRC message, the UE can decrypt the DCI transmission using the DCI encryption key. The UE can identify the DCI message portion of the decrypted DCI transmission and can determine a CRC of the DCI message using the C-RNTI of the UE. The UE can check the determined CRC against the eCRC message to verify the eCRC message.

In some cases, the wireless node may be a base station (e.g., an eNB, a gNB, or an equivalent or similar base station of a 6G wireless communications system) or a portion of a disaggregated base station, such as a central unit (CU), a distributed unit (DU), remote unit (RU), or other portion of the disaggregated base station. In some aspects, the DCI encryption key can be refreshed. In some cases, the DCI encryption key can be refreshed based on a system frame number wraparound (e.g., on each wraparound). In some cases, the refreshed DCI encryption key can be determined using an old DCI encryption key (e.g., where a current DCI encryption key is currently in use) and a freshness parameter. In other cases, the refreshed DCI encryption key may be determined based on a hyper frame number. The hyper frame number may be a 16-bit version of the system frame number which takes longer to wraparound as compared to a shorter length system frame number.

Additional aspects of the present disclosure are described in more detail below.

Wireless networks are deployed to provide various communication services, such as voice, video, packet data, messaging, broadcast, and the like. A wireless network may support both access links for communication between UEs. An access link may refer to any communication link between a client device (e.g., a user equipment (UE), a station (STA), or other client device) and a base station (e.g., a 3GPP gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

In some aspects, wireless communications networks may be implemented using one or more modulation schemes. For example, a wireless communication network may be implemented using a quadrature amplitude modulation (QAM) scheme such as 16 QAM, 32 QAM, 64 QAM, etc.

As used herein, the terms “user equipment” (UE), “wireless device,” and “network entity” are not intended to be specific or otherwise limited to any particular radio access technology (RAT), unless otherwise noted. In general, a UE may be any wireless device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

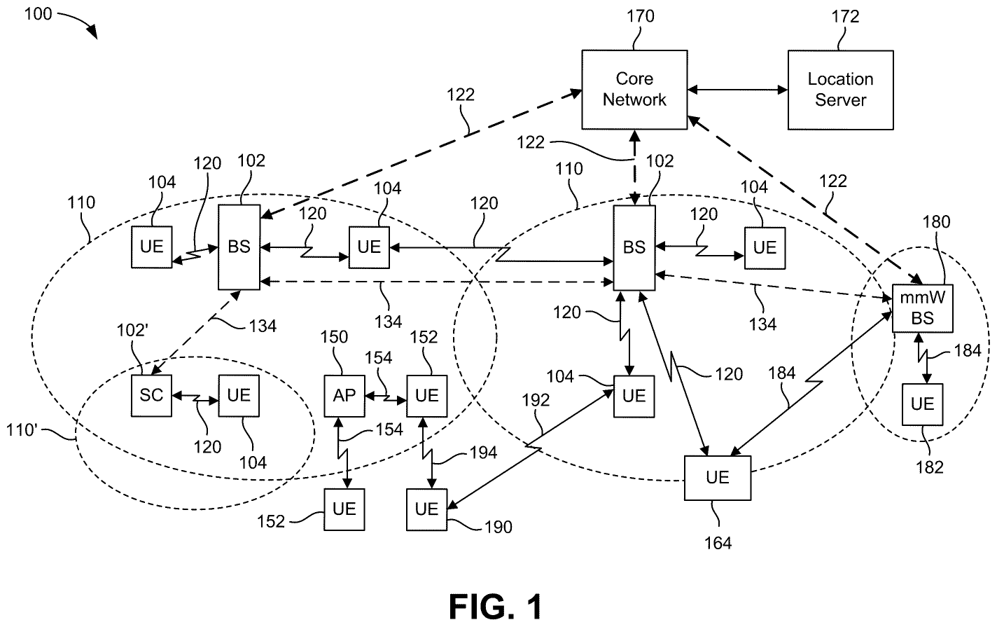

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

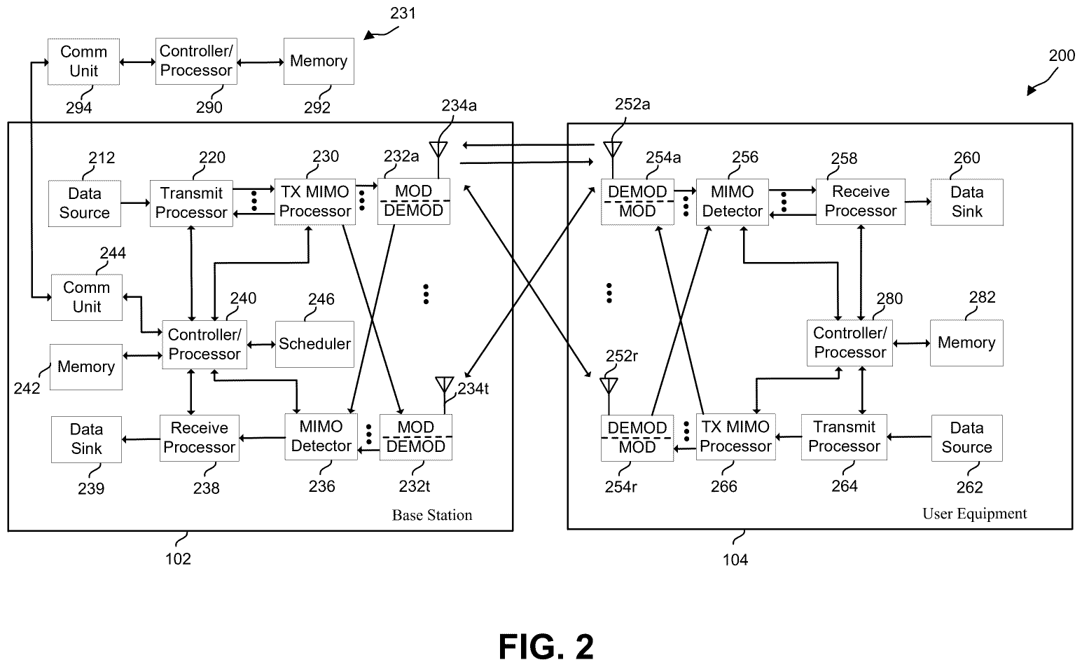

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

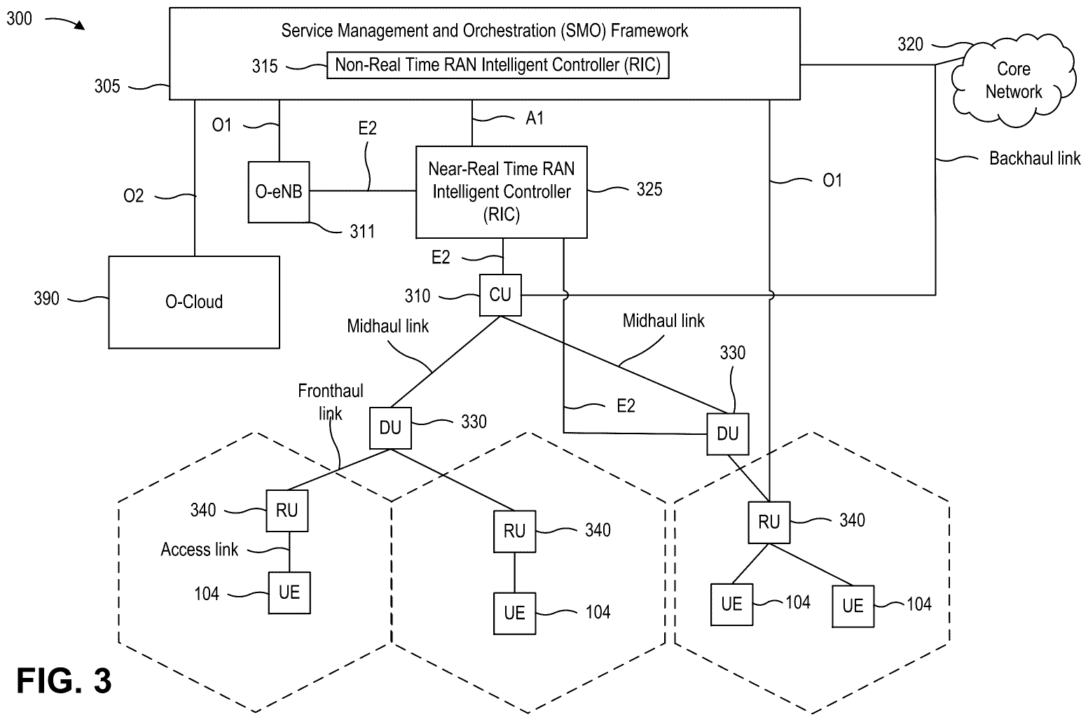

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as AI policies).

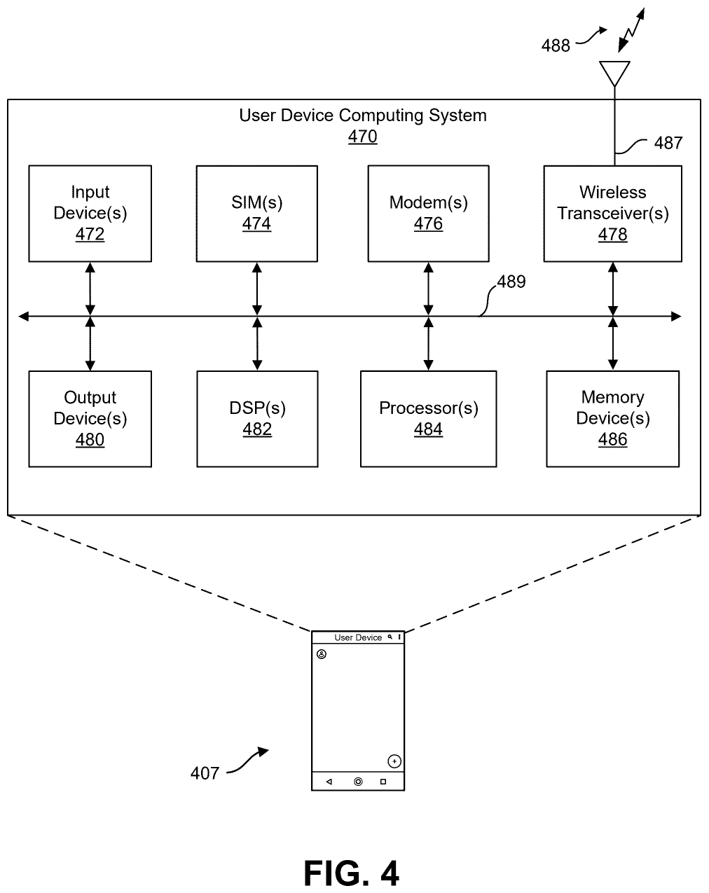

FIG. 4 illustrates an example of a computing system 470 of a UE 407. The UE 407 may include a client device such as a UE (e.g., UE 104, UE 152, UE 190) or other type of device (e.g., a station (STA) configured to communication using a Wi-Fi interface) that may be used by an end-user. For example, the UE 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other UEs, network devices (e.g., base stations such as eNBs and/or gNBs, Wi-Fi access points (APs) such as routers, range extenders or the like, etc.), cloud networks (e.g., server-based networks), and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a BluetoothTM network, and/or other network.

In some examples, the wireless signal 488 may be transmitted directly to other UEs using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other UEs.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the UE 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

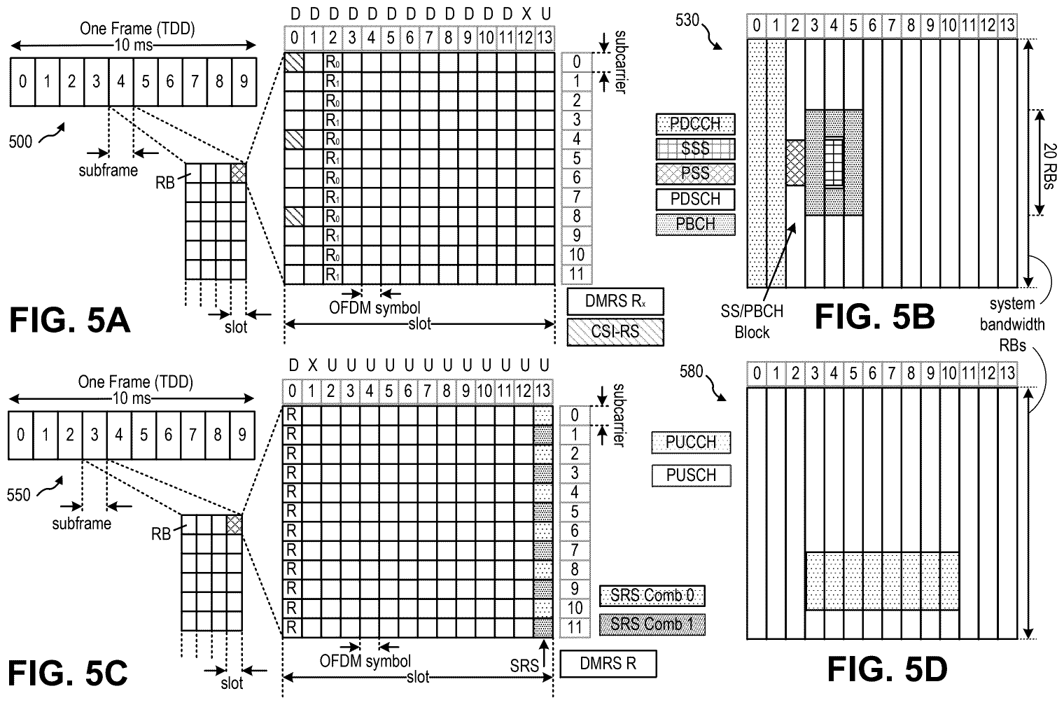

FIGS. 5A-5D depict various example aspects of data structures for a wireless communications system, such as wireless communications system 100 of FIG. 1. FIGS. 5A-5D depict aspects of data structures for a wireless communication network, such as wireless communication network 100 of FIG. 1. In particular, FIG. 5A is a diagram 500 illustrating an example of a first subframe within a 5G (e.g., 5G NR) frame structure, FIG. 5B is a diagram 530 illustrating an example of DL channels within a 5G subframe, FIG. 5C is a diagram 550 illustrating an example of a second subframe within a 5G frame structure, and FIG. 5D is a diagram 580 illustrating an example of UL channels within a 5G subframe.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 5A and 5C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 5A-5D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 5A, some of the REs carry reference (pilot) signals (RS) for a UE (e.g., UE 104, UE 152, UE 190). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 5B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., UE 104, UE 152, UE 190) to determine subframe/symbol timing and a physical layer identity. A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 5C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 5D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

In some cases, a UE may not be connected to a wireless network (e.g., when there is no non-access stratum (NAS) signaling connection between the UE and the wireless network). For example, a UE may just have been powered up, the UE may exit from an airplane mode, the UE enters a new service area, RRC reconfiguration, handover, and the like. This disconnected UE may be in an idle state and the UE may listen for wireless networks. After the UE identifies a wireless network, the UE may then attempt to connect to the wireless network. In some cases, the UE may attempt to connect to the wireless network via a wireless node (e.g., network node) to establish an RRC connection.

FIG. 6 illustrates an example connection procedure 600 to establish a connection with a wireless network, in accordance with aspects of the present disclosure. Connection procedure 600 includes messages exchanged between a UE 602 and network 604 (e.g., via a network node). In some cases, the connection procedure 600 may be a RACH procedure. In some cases, a Msg1 606 may be transmitted from the UE 602 to the network 604. The Msg1 606 may include a preamble from the UE 602 to access the network 604. In response to the Msg1 606, the network 604 may transmit a Msg2 608 to the UE 602. In some cases, the Msg2 608 may include initial information for connecting to the network node, such as timing alignment information, an initial uplink grant, and identifiers. The identifiers may include a preamble identifier, and a temporary cell radio network temporary identifier (C-RNTI). The temporary C-RNTI may be used to identify an RRC connection in a cell. In response to the Msg2 608, the UE 602 may transmit a Msg3 610 to the network 604. The Msg3 610 may be transmitted based on the initial uplink grant from Msg2 608 and the Msg3 610 may include an RRC message. The RRC message may be a request to set up an RRC connection. For example, Msg3 610 may include an RRCSetupRequest message.

The RRCSetupRequest may include an initial UE identifier(s) along with an establishment cause. In some cases, this initial UE identifier may include a portion of a temporary mobile subscriber identify (TMSI), and/or a 5G NR global unique identifier (5G-GUTI) and the C-RNTI. In some cases, the 5G-GUTI may be assigned to the UE 602 by the network 604 when the UE 602 registers with the network 604. In some cases, the TMSI may be derived based on the 5G-GUTI. The TMSI and/or the 5G-GUTI may be a core network identifier and may be maintained even if the RRC connection is lost. If the RRC setup is successful, Msg4 612 may be sent from the network 604 to the UE 602 to establish the RRC connection. In response to Msg4 612, the UE 602 may transmit Msg5 614. Msg5 614 may be a RRCSetupComplete message and the RRCSetupComplete may include the C-RNTI.

As indicated above, the DCI may be carried by the PDCCH and may be used to schedule when a UE may perform UL transmissions or receive DL messages. In some cases, the DCI may be generated by a network node (e.g., eNB, gNB, DU, RU, etc.) to schedule the UE and a single DCI may include scheduling information for multiple UEs (e.g., some or all of the UEs connected to the network node). In some cases, scheduling information in the DCI for a particular UE may be scrambled based on a C-RNTI of the particular UE. Thus, for a DCI with scheduling information, a particular UE may attempt to descramble the scheduling information based on the C-RNTI assigned to the UE and the scheduling information the UE is able to unscramble is the scheduling information for the UE. As the DCI is decoded by multiple UEs to determine whether the DCI is transmitted for itself, the overall DCI message may not be protected.

In some networks, a C-RNTI, as well as other RAN temporary identities (RNTIs), may be uniquely assigned to a UE and the C-RNTI may remain the same as long as the UE is connected to a particular network node. Additionally, as the C-RNTI may be sent to the UE as a part of setting up an RRC connection and before security between the UE and the network node is established, the C-RNTI may be transmitted in the clear. As the C-RNTI can go unchanged for a relatively long period of time (e.g., when connected to a network node near home, work, etc.) it may be possible to target an attack on/track a specific UE by linking a target UE's C-RNTI to the specific UE (e.g., personal identity of a user of the specific UE) via traffic analysis over time. Additionally, as the C-RNTI is used to scramble the scheduling information for the UE in the DCI, an attacker may eavesdrop on the DCI for a UE to identify resources scheduled for the UE to perform targeted attacks, for example, using traffic analysis, denial of service attacks, targeted jamming attacks that may be difficult to detect, manipulate the DCI/generate fake DCI messages, replay DCI messages, etc. Thus, techniques to protect DCI may be useful.

In some cases, it may be useful to use ciphering and integrity protection techniques to protect the DCI. Ciphering the DCI information may help hide information about which UE is scheduled for what resource. Ciphering may help prevent targeted attacks and/or difficult to launch attacks. Rather an attacker may have to attack an entire bandwidth (e.g., via jamming) to be effective. In some cases, DCI integrity protection (which is not provided by a cyclic redundance check (CRC) checksum as the CRC is a simple affine (or linear) transformation that may be worked around easily) may prevent attackers from being able to modify DCI content or inject fake DCI information.

In some cases, to allow DCI protection to be applied, a UE may have already had access stratum (AS) security setup, for example, based on an AS security mode command (SMC) procedure. In some cases, access stratum (AS) security may be used to secure a connection between the UE and a network node of the wireless system that is connected to the device. The AS security may apply a layer of security to a radio interface that connects a device to the network node of the wireless system. Whether to apply AS security may be determined by services of the wireless system being accessed by the device. For example, the device may access a service which may, based on a service security policy, enable AS security as between the device and the network node. Where the service determines that AS security should be enabled, the service may transmit a service key request to the security service. The security service may a service key response to the service to allow the service to establish a service security context with the device. The service may also register the service and device with a mobility service of the wireless system. The security service may derive an AS key and send the AS key to the network node. The network node may then use the AS key to establish an AS security context between the network node and the device. The UE may also derive the AS key based on parameter(s) exchanged between the UE and network node. In some cases, the AS security may be used to establish and maintain logical channels for transmitting and receiving data and control information over the air interface between the UE and a radio access network (RAN).

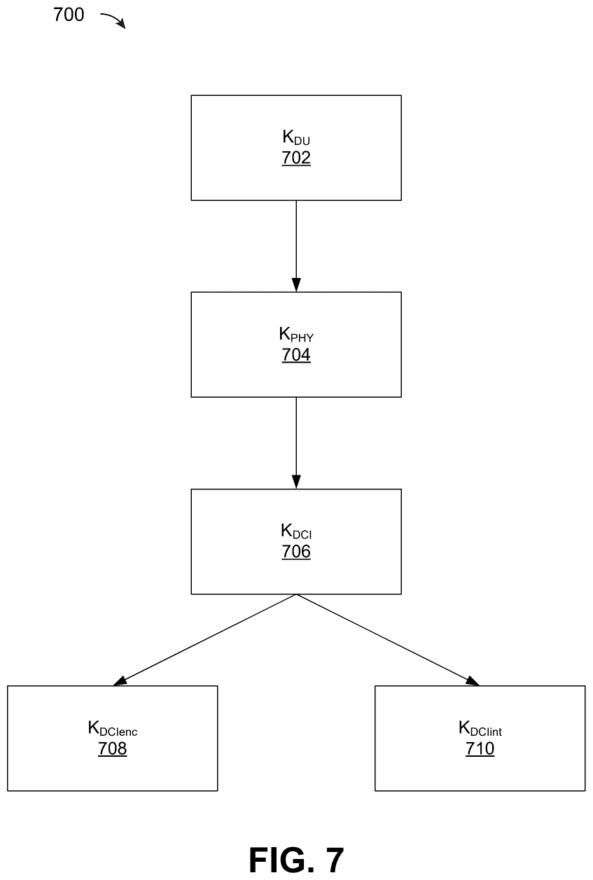

FIG. 7 illustrates a key hierarchy 700 for AS security of a wireless system, in accordance with aspects of the present disclosure. In some cases, AS security may be established based on a set of cryptographic keys. As a part of AS security, a UE and a network node, such as a BS, eNB, gNB, DU, etc., may share an AS key (e.g., may each derive the AS key based on exchanged parameter(s)) such as K_{DU} 702, or other AS root key (e.g., K_{gNB} (or K_{BS}) in 5G or an equivalent or similar key in 6G) and derive subsequent keys for control-plane signaling protection and user-plane data protection. In some cases, the UE and the network node may derive, from K_{DU} 702, a physical-layer key K_{PHY} 704 using a key derivation function (KDF) along with parameters (for example) such as the cell ID and frequency (e.g., absolute radio frequency channel number (ARFCN)), such that K_{PHY}=KDF (K_{DU}, cell ID, ARFCN). In some cases, such with a DU/RU split architecture, K_{PHY} 704 may be distinct for different RUs which are a part of different cells (e.g., as the cell ID may be used to derive K_{PHY} 704). Where a single RU includes multiple cells, a single K_{PHY} 704 may be used on cell change, and this may be signaled to the UE. After the K_{PHY} 704 is derived, a DCI key K_{DCI} 706 may be derived based on the K_{PHY} 704. In some cases, the DCI key K_{DCI} 706 may be derived using a KDF along with a context. The context may indicate what the derived key may be used for (e.g., generating a DCI protection key), as the K_{PHY} 704 may be used to generate other physical layer keys as well. Based on the K_{DCI} 706 other keys for DCI protection may be derived such as a DCI encryption key K_{DCIene} 708 and a DCI integrity protection key K_{DCIint} 710. In some cases, specific parameters that may be used for deriving a key (e.g., K_{PHY} 704, K_{DCI} 706, K_{DCIene} 708, or K_{DCIint} 710) may be configured as a part of AS security setup and the keys (e.g., K_{PHY} 704, K_{DCI} 706, K_{DCIene} 708, or K_{DCIint} 710) may be derived by both the network node and the UEs connected to the network node. In some cases, K_{DU} 702 may be derived based on a CU key K_{CU} in a 6G split architecture, which may be equivalent to a BS (e.g., K_{gNB}, K_{eNB}, or equivalent) for LTE/5G.

In some cases, a freshness parameter may be used when using any of the K_{DCIene} 708, or K_{DCIint} 710 keys for encrypting a message. The freshness parameter may be a value that may input into a KDF for deriving a key that help increase uniqueness of the key. Examples of values for the freshness parameter may include a system frame number (SFN) subframe number, slot number, MAC-TB ID, bandwidth part (BWP), channel information, etc. However, these values may not be sufficient to guarantee uniqueness over time as the same keys may be used due to SFN wraparound. For example, the SFN may be incremented in 10 ms intervals from 0 to a maximum SFN value of 1023, after which the SFN wraparounds to 0. Thus, the SFN wraparound may occur approximately every 10 seconds. The SFN wraparound may cause the derived keys to be repeated (e.g., key reused) relatively often. In some cases, to help avoid key reuse, a new K_{DCI} 706 may derived every SFN wraparound (or before SFN wraparound) using the current K_{DCI} and a parameter such that K_{DCI}=KDF (KD_{CI}, param), where param may be a cell specific parameter, such as a physical cell IP (PCI). Key reuse may also be avoided by using a hyper frame number (e.g., a 16-bit number) or an overflow counter which may increase key lifetime to approximately 186 hours.

In some cases, DCI protection may be applied for unicast DCI transmissions (e.g., DCI transmission to a single UE). In some cases, the DCI message format for the DCI message may be the same as used in wireless systems without DCI protection (e.g., 5G, LTE, etc.). A DCI message using such a DCI message format may include DCI information (e.g., scheduling information for a UE) along with a cyclic redundancy check (CRC) portion of the DCI message. As a part of DCI protection, DCI encryption may be applied to the entire DCI message. For example, a whole DCI message, including the CRC check of the DCI message, for a UE may be encrypted using the DCI encryption key KDCIenc 708 and a freshness parameter to generate an encrypted DCI message. Integrity protection may be applied to the encrypted DCI message by generating a message authentication code (MAC) using the DCI integrity protection key K_{DCIint} 710 and a freshness parameter. In some cases, the MAC may be a 16 bit or 32 bit code and the MAC may be appended on the encrypted DCI message to generate a protected DCI message for transmission to a target UE.

Upon receipt of the protected DCI message, the UE may verify the protected DCI message by generating a MAC using the encrypted DCI message portion of the protected DCI message and the DCI integrity protection key K_{DCIint} 710 generated by the UE. The UE may compare the generated MAC with the MAC appended to the encrypted DCI message. If the generated MAC matches the MAC appended to the encrypted DCI message, the DCI message may be verified and the UE may decrypt the encrypted DCI message using the DCI encryption key KDCIenc 708 generated by the UE. If the generated MAC does not match the MAC appended to the encrypted DCI message, then the UE may determine that the protected DCI message is not verified and raise an error.

Appending a MAC to the encrypted DCI message may result in a larger overall protected DCI message as compared to an unprotected DCI message, which may result in an increase in DCI signaling overhead. In some cases, it may be useful to reduce this additional DCI signaling overhead. One option to reduce the additional DCI signaling overhead is to use the MAC in place of the CRC as the MAC may provide more comprehensive integrity protection as compared to the CRC. In some cases, an encrypt-then-MAC strategy may be used. As an example, the DCI message may be encrypted using K_{DCIene} 708, the MAC generated using K_{DCIint} 710 on the encrypted DCI message, and the generated MAC appended to the encrypted DCI message. A UE may then determine a MAC based on the encrypted DCI message and compare the determined MAC to the MAC appended to the DCI message to verify the integrity of the encrypted DCI message. As another example, a MAC-then-encrypt strategy may be used. For example, the MAC may be generated using K_{DCIint} 710 based on the DCI message and the generated MAC may be appended to the DCI message. The DCI message and appended MAC may then be encrypted using K_{DCIene} 708. By removing the CRC, the computational resources overhead may be reduced. As yet another example, authenticated encryption with additional data (AEAD) may be used. AEAD may be a technique for single pass encryption and integrity protection.

A second option to reduce the additional DCI signaling overhead is to use an enhanced CRC (eCRC). In an eCRC, a C-RNTI for a target UE may be used in the CRC determination. In some cases, C-RNTI may be sent to the target UE by the network node using a secure RRC message. The CRC may be calculated over the DCI message and C-RNTI and appended to the DCI message as the eCRC. The DCI message and the appended eCRC may be encrypted using the DCI encryption key K_{DCIene} 708. In some cases, the eCRC may no longer be an affine function to an attacker as the attacker may not know the C-RNTI to calculate the eCRC. However, as the UE has the C-RNTI, the UE can calculate the eCRC. For example, the UE may receive the DCI transmission and use the DCI encryption key K_{DCIene} 708 generated by the UE to decrypt the DCI transmission to obtain the DCI message and eCRC. The UE may then determine the eCRC using the DCI message and its C-RNTI. In cases where an eCRC is used for the DCI signaling, the C-RNTI should be allocated/reallocated by the network node after AS security is established.

In some cases, DCI protection may be applied to an RRC connected UE that has been allocated with a C-RNTI from the serving network node (e.g., cell (RU), DU, eNB, gNB, etc.). For example, the K_{DU} key may be exchanged via secure RRC messages along with parameters for deriving additional keys from the K_{DU} key. In some cases, the RRC protocol (e.g., stack) may reside in a DU, in an RRC service (e.g., CU-CP equivalent for 6G), in the core network (e.g., a cloud or other server-based network), or both in the DU and in the core network with split functionality.

In some cases, after a UE may start using the DCI protection keys (e.g., K_{DCIene}, K_{DCIint}) on initial access after sending the AS security mode complete message to the target network node. On handover, the UE may start using the DCI protection keys after sending an RRC reconfiguration complete message (e.g., in response to an RRC reconfiguration message) to the target network node. For radio link failure recovery, the UE may start using the DCI protection keys after sending an RRC reestablishment message to the target network node. For exiting an RRC inactive state, the UE mat start using the DCI protection keys after sending an RRC resume message to the target network node.

In some cases, a network node may start using DCI protection keys (e.g., K_{DCIene}, K_{DCIint}) on initial access of the UE after receiving the AS security mode complete message from the UE. On handover, the network node may start using the DCI protection keys after receiving an RRC reconfiguration complete message from the UE. For radio link failure recovery, the network node may start using the DCI protection keys after receiving an RRC reestablishment message from the UE. For exiting an RRC inactive state, the network node mat start using the DCI protection keys after receiving an RRC resume message from the UE.

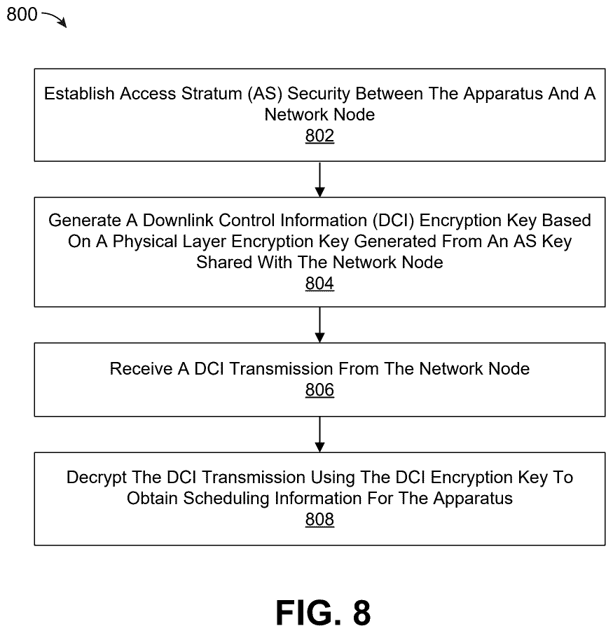

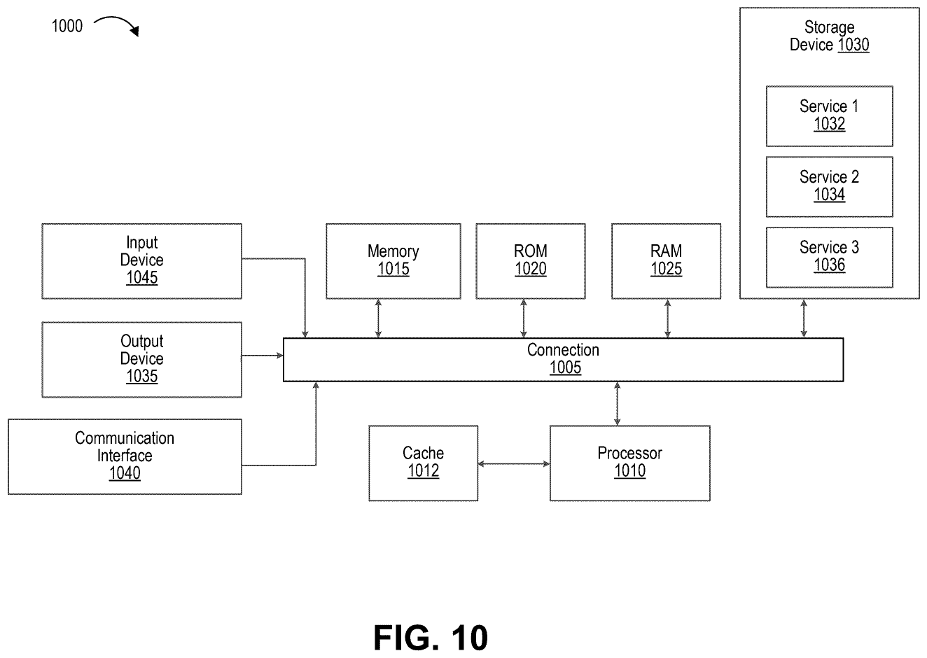

FIG. 8 is a flow diagram of a process 800 for wireless communications, in accordance with aspects of the present disclosure. The process 800 may be performed by a computing device (or apparatus) or a component (e.g., a chipset, codec, etc.) of the computing device. The computing device may be wireless device (e.g., a UE, such as one of the UEs 104, 190, 152, 164, and 182 of FIG. 1, UE 104 of FIGS. 2-3, UE 407 of FIG. 4, computing system 1000 of FIG. 10, or other wireless device). In some cases, the computing device can be a mobile device (e.g., a mobile phone, a tablet computer, etc.), a network-connected wearable such as a watch, an extended reality (XR) device such as a virtual reality (VR) device or augmented reality (AR) device, a vehicle or component or system of a vehicle, or other type of computing device. The operations of the process 800 may be implemented as software components that are executed and run on one or more processors (e.g., controller/processor 280 of FIG. 2, processor 484 of FIG. 4, processor 1010 of FIG. 10, etc.).

At block 802, the computing device (or component thereof) may establish access stratum (AS) security between the computing device and a network node (e.g., a base station 102, AP 150, mmW base station 180 of FIG. 1, DU 330 of FIG. 3, RU 340 of FIG. 3, CU 310 of FIG. 3, etc.).

At block 804, the computing device (or component thereof) may generate a downlink control information (DCI) encryption key based on a physical layer encryption key generated from an AS key (e.g., K_{DU} 702 of FIG. 7, or other AS root key (e.g., K_{gNB} (or K_{BS}) in 5G or an equivalent or similar key in 6G)) shared with the network node. In some cases, a security service may derive an AS key and send the AS key to the network node. The wireless device may also derive the AS key based on parameter(s) exchanged between the wireless device and network node (e.g., as a part of an AS security mode command (SMC) procedure). In some cases, the network node comprises a distributed unit (DU) and the AS key comprises a DU key. In some examples, the computing device (or component thereof) may generate a downlink control information (DCI) integrity protection key (e.g., DCI integrity protection key K_{DCIint} 710 of FIG. 7) based on the physical layer encryption key.

At block 806, the computing device (or component thereof) may receive a DCI transmission from the network node. In some cases, the DCI transmission includes an encrypted DCI message and a message authentication code (MAC). In some examples, the computing device (or component thereof) may determine a first MAC based on an encrypted DCI message of the DCI transmission using the DCI integrity protection key and verify an integrity of the DCI transmission based on a comparison between the first MAC and a second MAC appended to the encrypted DCI message in the DCI transmission. In some cases, the encrypted DCI message includes a cyclic redundancy check (CRC) message. In some examples, the computing device (or component thereof) may decrypt the DCI transmission before verifying the integrity of the DCI transmission.

At block 808, the computing device (or component thereof) may decrypt the DCI transmission using the DCI encryption key to obtain scheduling information for the computing device. In some cases, the computing device (or component thereof) may refresh the DCI encryption key using a current DCI encryption key and a freshness parameter. The freshness parameter may be a value that may input into a KDF for deriving a key that help increase uniqueness of the key. In some cases, the computing device (or component thereof) may refresh the DCI encryption key based on a system frame number wraparound. In some examples, the computing device (or component thereof) may refresh the DCI encryption key based on a hyper frame number. In some cases, the DCI transmission includes a DCI message and a first enhanced cyclic redundancy check (eCRC) message. In some examples, the computing device (or component thereof) may decrypt the DCI transmission to obtain the DCI message, determine a second eCRC message based on the DCI message and a cell radio network temporary identifier (C-RNTI) of the computing device, and verify an integrity of the DCI transmission based on a comparison between the first eCRC message and the second eCRC message.

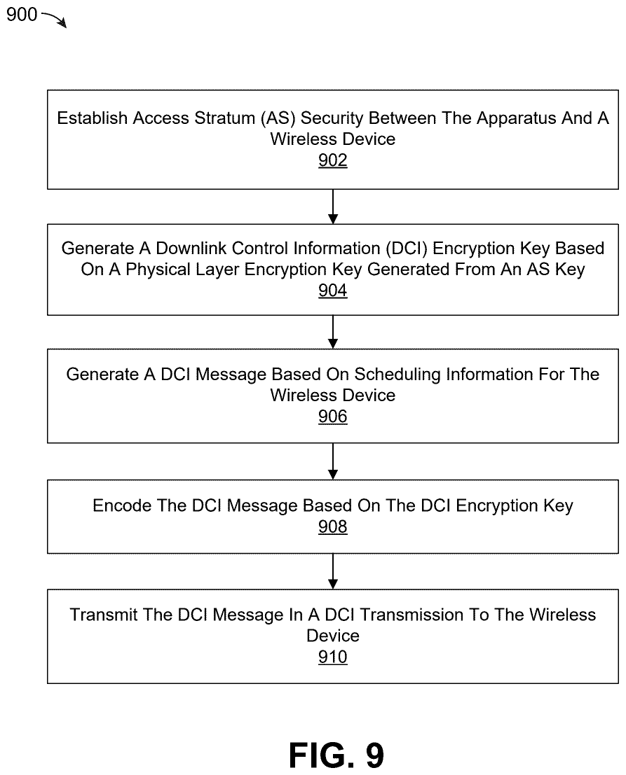

FIG. 9 is a flow diagram of a process 900 for wireless communications, in accordance with aspects of the present disclosure. The process 900 may be performed by a computing device (or apparatus) or a component (e.g., a chipset, codec, etc.) of the computing device. The computing device may be a network node/entity/device (e.g., a base station 102, AP 150, mmW base station 180 of FIG. 1, DU 330 of FIG. 3, RU 340 of FIG. 3, CU 310 of FIG. 3, etc.), network device, or other type of computing device. The operations of the process 900 may be implemented as software components that are executed and run on one or more processors (e.g., controller/processor 240 of FIG. 2, processor 1010 of FIG. 10, etc.).

At block 902, the computing device (or component thereof) may establish access stratum (AS) security between the computing device and a wireless device (e.g., UEs 104, 190, 152, 164, and 182 of FIG. 1, UE 104 of FIGS. 2-3, UE 407 of FIG. 4, or other wireless device). In some cases, the computing device may be a distributed unit (DU). In some examples, the AS key comprises a DU key.

At block 904, the computing device (or component thereof) may generate a downlink control information (DCI) encryption key based on a physical layer encryption key generated from an AS key (e.g., K_{DU} 702 of FIG. 7, or other AS root key (e.g., K_{gNB} (or K_{BS}) in 5G or an equivalent or similar key in 6G)). In some cases, a security service of a wireless network may derive an AS key and send the AS key to the network node. In some cases, the wireless device and the network node may derive, from the AS key, a physical-layer encryption key, such as K_{PHY} 704 of FIG. 7. The network node may derive the DCI encryption key from the physical layer key. In some examples, the computing device (or component thereof) may refresh the DCI encryption key using a current DCI encryption key and a freshness parameter. In some cases, the computing device (or component thereof) may refresh the DCI encryption key based on a system frame number wraparound. In some examples, the computing device (or component thereof) may refresh the DCI encryption key based on a hyper frame number.

At block 906, the computing device (or component thereof) may generate a DCI message based on scheduling information for the wireless device.

At block 908, the computing device (or component thereof) may encode the DCI message based on the DCI encryption key. In some examples, the computing device (or component thereof) may generate a downlink control information (DCI) integrity protection key (e.g., DCI integrity protection key K_{DCIint} 710 of FIG. 7) based on the physical layer encryption key. In some cases, the computing device (or component thereof) may determine a message authentication code (MAC) based on the DCI integrity protection key and the DCI message; and append the MAC to the DCI message for transmission. In some examples, the encrypted DCI message includes a cyclic redundancy check (CRC) message. In some cases, the computing device (or component thereof) may append the MAC to the DCI message before encoding the DCI message. In some cases, the computing device (or component thereof) may concatenate the DCI message with a cell radio network temporary identifier (C-RNTI) of the wireless device, determine an enhanced cyclic redundancy check (eCRC) message based on the concatenated DCI message and C-RNTI, and append the eCRC to the DCI message for transmission.

At block 910, the computing device (or component thereof) may transmit the DCI message in a DCI transmission to the wireless device.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 800, process 900, and/or other processes described herein may include a processor, microprocessor, micro-computer, or other component of a device that is configured to carry out the steps of the process 800, process 900, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 800, process 900, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 800 and process 900 are illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 800, process 900, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a diagram illustrating an example of a system for implementing certain aspects of the present technology. In particular, FIG. 10 illustrates an example of computing system 1000, which may be for example any computing device making up internal computing system, a remote computing system, a camera, or any component thereof in which the components of the system are in communication with each other using connection 1005. Connection 1005 may be a physical connection using a bus, or a direct connection into processor 1010, such as in a chipset architecture. Connection 1005 may also be a virtual connection, networked connection, or logical connection.

In some embodiments, computing system 1000 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 may include a cache 1012 of high-speed memory connected directly with, in close proximity to, or integrated as part of processor 1010.

Processor 1010 may include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which may represent any number of input mechanisms, such as a microphone for speech, a touch-sensitive screen for gesture or graphical input, keyboard, mouse, motion input, speech, etc. Computing system 1000 may also include output device 1035, which may be one or more of a number of output mechanisms. In some instances, multimodal systems may enable a user to provide multiple types of input/output to communicate with computing system 1000.

Computing system 1000 may include communications interface 1040, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 may include software services, servers, services, etc., that when the code that defines such software is executed by the processor 1010, it causes the system to perform a function. In some embodiments, a hardware service that performs a particular function may include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for wireless communications, comprising: a memory comprising instructions; and a processor coupled to the memory and configured to: establish access stratum (AS) security between the apparatus and a network node; generate a downlink control information (DCI) encryption key based on a physical layer encryption key generated from an AS key shared with the network node; receive a DCI transmission from the network node; and decrypt the DCI transmission using the DCI encryption key to obtain scheduling information for the apparatus.
Aspect 2. The apparatus of Aspect 1, wherein the network node comprises a distributed unit (DU) and wherein the AS key comprises a DU key.
Aspect 3. The apparatus of any of Aspects 1-2, wherein the processor is further configured to refresh the DCI encryption key using a current DCI encryption key and a freshness parameter.
Aspect 4. The apparatus of Aspect 3, the processor is further configured to refresh the DCI encryption key based on a system frame number wraparound.
Aspect 5. The apparatus of any of Aspects 1-2, wherein the processor is further configured to refresh the DCI encryption key based on a hyper frame number.
Aspect 6. The apparatus of any of Aspects 1-5, wherein the processor is further configured to generate a DCI integrity protection key based on the physical layer encryption key.
Aspect 7. The apparatus of Aspect 6, wherein the DCI transmission includes an encrypted DCI message and a message authentication code (MAC), and wherein the processor is further configured to: determine a first MAC based on an encrypted DCI message of the DCI transmission using the DCI integrity protection key; and verify an integrity of the DCI transmission based on a comparison between the first MAC and a second MAC appended to the encrypted DCI message in the DCI transmission.
Aspect 8. The apparatus of Aspect 7, wherein the encrypted DCI message includes a cyclic redundancy check (CRC) message.
Aspect 9. The apparatus of any of Aspects 7-8, wherein the processor is further configured to decrypt the DCI transmission before verifying the integrity of the DCI transmission.
Aspect 10. The apparatus of any of Aspects 1-9, wherein the DCI transmission includes a DCI message and a first enhanced cyclic redundancy check (eCRC) message, and wherein the processor is further configured to: decrypt the DCI transmission to obtain the DCI message; determine a second eCRC message based on the DCI message and a cell radio network temporary identifier (C-RNTI) of the apparatus; and verify an integrity of the DCI transmission based on a comparison between the first eCRC message and the second eCRC message.
Aspect 11. A method for wireless communications, comprising: establishing, by a wireless device, access stratum (AS) security between the wireless device and a network node; generating a downlink control information (DCI) encryption key based on a physical layer encryption key generated from an AS key shared with the network node; receiving a DCI transmission from the network node; and decrypting the DCI transmission using the DCI encryption key to obtain scheduling information for the wireless device.
Aspect 12. The method of Aspect 11, wherein the network node comprises a distributed unit (DU) and wherein the AS key comprises a DU key.
Aspect 13. The method of any of Aspects 11-12, further comprising refreshing the DCI encryption key using a current DCI encryption key and a freshness parameter.
Aspect 14. The method of Aspect 13, further comprising refreshing the DCI encryption key based on a system frame number wraparound.
Aspect 15. The method of any of Aspects 11-12, further comprising refreshing the DCI encryption key based on a hyper frame number.
Aspect 16. The method of any of Aspects 11-15, further comprising generating a DCI integrity protection key based on the physical layer encryption key.
Aspect 17. The method of Aspect 16, wherein the DCI transmission includes an encrypted DCI message and a message authentication code (MAC), and further comprising: determining a first MAC based on an encrypted DCI message of the DCI transmission using the DCI integrity protection key; and verifying an integrity of the DCI transmission based on a comparison between the first MAC and a second MAC appended to the encrypted DCI message in the DCI transmission.
Aspect 18. The method of Aspect 17, wherein the encrypted DCI message includes a cyclic redundancy check (CRC) message.
Aspect 19. The method of any of Aspects 17-18, further comprising decrypting the DCI transmission before verifying the integrity of the DCI transmission.
Aspect 20. The method of any of Aspects 11-19, wherein the DCI transmission includes a DCI message and a first enhanced cyclic redundancy check (eCRC) message, and further comprising: decrypting the DCI transmission to obtain the DCI message; determining a second eCRC message based on the DCI message and a cell radio network temporary identifier (C-RNTI) of the wireless device; and verifying an integrity of the DCI transmission based on a comparison between the first eCRC message and the second eCRC message.
Aspect 21. An apparatus for wireless communications, comprising: a memory comprising instructions; and a processor coupled to the memory and configured to: establish access stratum (AS) security between the apparatus and a wireless device; generate a downlink control information (DCI) encryption key based on a physical layer encryption key generated from an AS key; generate a DCI message based on scheduling information for the wireless device; encode the DCI message based on the DCI encryption key; and transmit the DCI message in a DCI transmission to the wireless device.
Aspect 22. The apparatus of Aspect 21, wherein the apparatus comprises a distributed unit (DU) and wherein the AS key comprises a DU key.
Aspect 23. The apparatus of any of Aspects 21-22, wherein the processor is further configured to refresh the DCI encryption key using a current DCI encryption key and a freshness parameter.
Aspect 24. The apparatus of Aspect 23, wherein the processor is further configured to refresh the DCI encryption key based on a system frame number wraparound.
Aspect 25. The apparatus of any of Aspects 21-22, wherein the processor is further configured to refresh the DCI encryption key based on a hyper frame number.
Aspect 26. The apparatus of any of Aspects 21-25, wherein the processor is further configured to generate a DCI integrity protection key based on the physical layer encryption key.
Aspect 27. The apparatus of Aspect 26, wherein the processor is further configured to: determine a message authentication code (MAC) based on the DCI integrity protection key and the DCI message; and append the MAC to the DCI message for transmission.
Aspect 28. The apparatus of Aspect 27, wherein the encrypted DCI message includes a cyclic redundancy check (CRC) message.
Aspect 29. The apparatus of any of Aspects 27-28, wherein the processor is further configured to append the MAC to the DCI message before encoding the DCI message.
Aspect 30. The apparatus of any of Aspects 21-29, wherein the processor is further configured to: concatenate the DCI message with a cell radio network temporary identifier (C-RNTI) of the wireless device; determine an enhanced cyclic redundancy check (eCRC) message based on the concatenated DCI message and C-RNTI; and append the eCRC to the DCI message for transmission.
Aspect 31. A method for performing operations according to any one or more of Aspects 21-30.
Aspect 32. An apparatus comprising means for performing operations according to any of Aspects 11 to 20.
Aspect 33. apparatus comprising means for performing a method according to any of Aspects 21 to 30.
Aspect 34. A non-transitory computer-readable medium having stored thereon instructions that, when executed by at least one processor, cause the at least one processor to perform operations according to any of Aspects 11 to 20.
Aspect 35. non-transitory computer-readable medium having stored thereon instructions that, when executed by at least one processor, cause the at least one processor to perform operations according to any of Aspects 11 to 30.

What is claimed is:

1. An apparatus for wireless communications, comprising:
a memory comprising instructions; and
a processor coupled to the memory and configured to:
establish access stratum (AS) security between the apparatus and a network node;
generate a downlink control information (DCI) encryption key based on a physical layer encryption key generated from an AS key shared with the network node;
receive a DCI transmission from the network node; and
decrypt the DCI transmission using the DCI encryption key to obtain scheduling information for the apparatus.

2. The apparatus of claim 1, wherein the network node comprises a distributed unit (DU) and wherein the AS key comprises a DU key.

3. The apparatus of claim 1, wherein the processor is further configured to refresh the DCI encryption key using a current DCI encryption key and a freshness parameter.

4. The apparatus of claim 3, the processor is further configured to refresh the DCI encryption key based on a system frame number wraparound.

5. The apparatus of claim 1, wherein the processor is further configured to refresh the DCI encryption key based on a hyper frame number.

6. The apparatus of claim 1, wherein the processor is further configured to generate a DCI integrity protection key based on the physical layer encryption key.

7. The apparatus of claim 6, wherein the DCI transmission includes an encrypted DCI message and a message authentication code (MAC), and wherein the processor is further configured to:
determine a first MAC based on an encrypted DCI message of the DCI transmission using the DCI integrity protection key; and
verify an integrity of the DCI transmission based on a comparison between the first MAC and a second MAC appended to the encrypted DCI message in the DCI transmission.

8. The apparatus of claim 7, wherein the encrypted DCI message includes a cyclic redundancy check (CRC) message.

9. The apparatus of claim 7, wherein the processor is further configured to decrypt the DCI transmission before verifying the integrity of the DCI transmission.

10. The apparatus of claim 1, wherein the DCI transmission includes a DCI message and a first enhanced cyclic redundancy check (eCRC) message, and wherein the processor is further configured to:
decrypt the DCI transmission to obtain the DCI message;
determine a second eCRC message based on the DCI message and a cell radio network temporary identifier (C-RNTI) of the apparatus; and
verify an integrity of the DCI transmission based on a comparison between the first eCRC message and the second eCRC message.

11. A method for wireless communications, comprising:
establishing, by a wireless device, access stratum (AS) security between the wireless device and a network node;
generating a downlink control information (DCI) encryption key based on a physical layer encryption key generated from an AS key shared with the network node;
receiving a DCI transmission from the network node; and
decrypting the DCI transmission using the DCI encryption key to obtain scheduling information for the wireless device.

12. The method of claim 11, wherein the network node comprises a distributed unit (DU) and wherein the AS key comprises a DU key.

13. An apparatus for wireless communications, comprising:
a memory comprising instructions; and
a processor coupled to the memory and configured to:
establish access stratum (AS) security between the apparatus and a wireless device;
generate a downlink control information (DCI) encryption key based on a physical layer encryption key generated from an AS key;
generate a DCI message based on scheduling information for the wireless device;
encode the DCI message based on the DCI encryption key; and
transmit the DCI message in a DCI transmission to the wireless device.

14. The apparatus of claim 13, wherein the apparatus comprises a distributed unit (DU) and wherein the AS key comprises a DU key.

15. The apparatus of claim 13, wherein the processor is further configured to refresh the DCI encryption key using a current DCI encryption key and a freshness parameter.

16. The apparatus of claim 13, wherein the processor is further configured to refresh the DCI encryption key based on a system frame number wraparound.

17. The apparatus of claim 13, wherein the processor is further configured to refresh the DCI encryption key based on a hyper frame number.

18. The apparatus of claim 13, wherein the processor is further configured to generate a DCI integrity protection key based on the physical layer encryption key.

19. The apparatus of claim 18, wherein the processor is further configured to:
determine a message authentication code (MAC) based on the DCI integrity protection key and the DCI message; and
append the MAC to the DCI message for transmission.

20. The apparatus of claim 13, wherein the processor is further configured to:
concatenate the DCI message with a cell radio network temporary identifier (C-RNTI) of the wireless device;
determine an enhanced cyclic redundancy check (eCRC) message based on the concatenated DCI message and C-RNTI; and
append the eCRC to the DCI message for transmission.
